(19) United States
(12) Patent Application Publication
(10) Pub. No.: US 2022/0222573 A1
(43) Pub. Date: Jul. 14, 2022

(54) RUNNING TESTS IN DATA DIGEST MACHINE-LEARNING MODEL

(71) Applicant: Arm Cloud Technology, Inc., San Jose, CA (US)

(72) Inventors: John Ronald FRY, Campbell, CA (US); Ardaman SINGH, Union City, CA (US); Bernard BURG, Menlo Park, CA (US)

(21) Appl. No.: 17/147,702

(22) Filed: Jan. 13, 2021

(51) Int. Cl. G06N 20/00

(52) U.S. Cl. CPC G06N 20/00

(57) ABSTRACT

A method of operating a model-based machine-learning data digest system comprises acquiring and storing data input at one quality level transforming the input into a first transform output usable by a machine learning component; performing a first test iteration of the machine learning component on the first transform output; retrieving the first quality level saved data; modifying the retrieved copy to a second quality level; transforming the retrieved copy into a second transform output usable by a machine learning component; performing a second test iteration on the second transform output; comparing validity measures of the first and the second test output; and if a validity measure of the second test output is equal to or greater than a validity measure of the first test output, instructing the data source to provide at least one future instance of data input at the second data quality level.

The present technology relates to methods and apparatus for controlling a model-based machine learning data digest system, in which data is acquired from data sources, transformed into a format in which it is consumable by the machine-learning model, and used by the model to produce usefully-applicable outcomes.

As the computing art has advanced, and as processing power, memory and the like resources have become commoditised and capable of being incorporated into objects used in everyday living, there has arisen what is known as the Internet of Things (IoT). Many of the devices that are used in daily life for purposes connected with, for example, transport, home life, shopping and exercising are now capable of incorporating some form of data collection, processing, storage and production in ways that could not have been imagined in the early days of computing, or even quite recently. Well-known examples of such devices in the consumer space include wearable fitness tracking devices, automobile monitoring and control systems, refrigerators that can scan product codes of food products and store date and freshness information to suggest buying priorities by means of text messages to mobile (cellular) telephones, and the like. In industry and commerce, instrumentation of processes, premises, and machinery has likewise advanced apace. In the spheres of healthcare, medical research and lifestyle improvement, advances in implantable devices, remote monitoring and diagnostics and the like technologies are proving transformative, and their potential is only beginning to be tapped.

In an environment replete with these IoT devices, there is an abundance of data which is available for processing by analytical systems enriched with artificial intelligence (AI), machine learning (ML) and analytical discovery techniques to produce valuable insights, provided that the data can be appropriately digested and prepared for the application of analytical tools. Data for use by such analysis systems may be provided by sensors, such as accelerometers and temperature gauges, by automated systems such as GPS-enabled vehicle systems, by user inputs via point-of-sale barcode scanning devices, and many other examples. The data itself may be of many types, such as voice data, image data, and analog or digital numeric data. This plethora of potential data types and acquisition methods typically requires rather sophisticated data handling and transformation technologies to make it usable by machine-learning systems to produce reasoned outcomes that can be used in the real world—for controlling, for example, manufacturing and materials handling machinery or robotics, agricultural and horticultural systems, commercial and financial transaction technologies, and domestic, health and lifestyle systems. Machine learning technologies can thus take advantage of this very broad range of data sources and types, and by means of the “experience” acquired in the course of repetitive training, can learn to reason over the data to produce informed outcomes that are applicable to addressing real-world problems.

Difficulties abound in this field, particularly when data is sourced from a multiplicity of incompatible devices and over a multiplicity of incompatible communications channels. It would, in such cases, be desirable to provide facilities to improve the operation of the data digest system to provide improved efficiencies in functioning of the machine learning model.

In a first approach to some of the many difficulties encountered in controlling a data digest system, the presently disclosed technology provides a computer-implemented method of operation of a model-based machine learning data digest system comprising computer-implemented method of operation of a model-based machine learning data digest system comprising acquiring a data input at a first data quality level originating at a data source; storing a save copy of the data input at the first data quality level; transforming the data input through at least one intermediate data state into a first transform output in a form usable by a model-based machine learning component; performing a first test iteration of operation of the model-based machine learning component on the first transform output to derive a first test output; retrieving the save copy of the data input at the first data quality level; modifying the retrieved save copy to a second data quality level; transforming the retrieved copy through at least one intermediate data state into a second transform output in a form usable by a model-based machine learning component; performing a second test iteration of operation of the model-based machine learning component on the second transform output to derive a second test output; comparing at least one validity measure of the first and the second test output; and responsive to a finding that the at least one validity measure of the second test output is equal to or greater than the at least one validity measure of the first test output, communicating an instruction to the data source to provide at least one future instance of data input at the second data quality level.

In a hardware approach, there is provided electronic apparatus comprising electronic logic components operable to implement the methods of the present technology. In another approach, the computer-implemented method may be realised in the form of a computer program product.

Implementations of the disclosed technology will now be described, by way of example only, with reference to the accompanying drawings, in which:

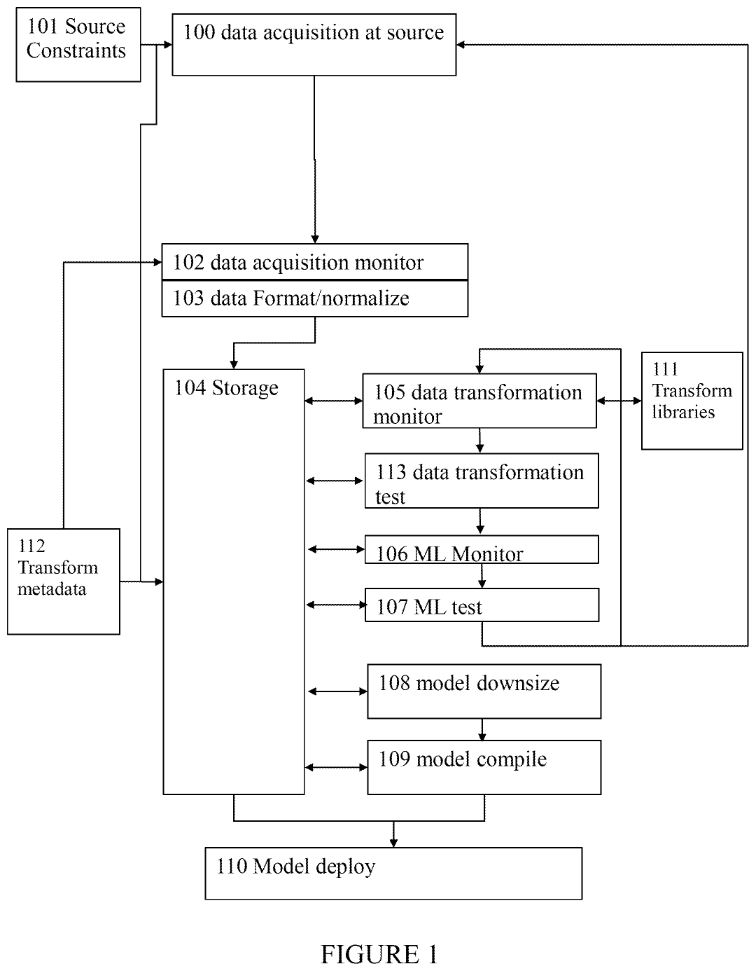

FIG. 1 shows a block diagram of an arrangement of logic, firmware or software components comprising a data digest and machine learning system according to an implementation of the presently described technology; and

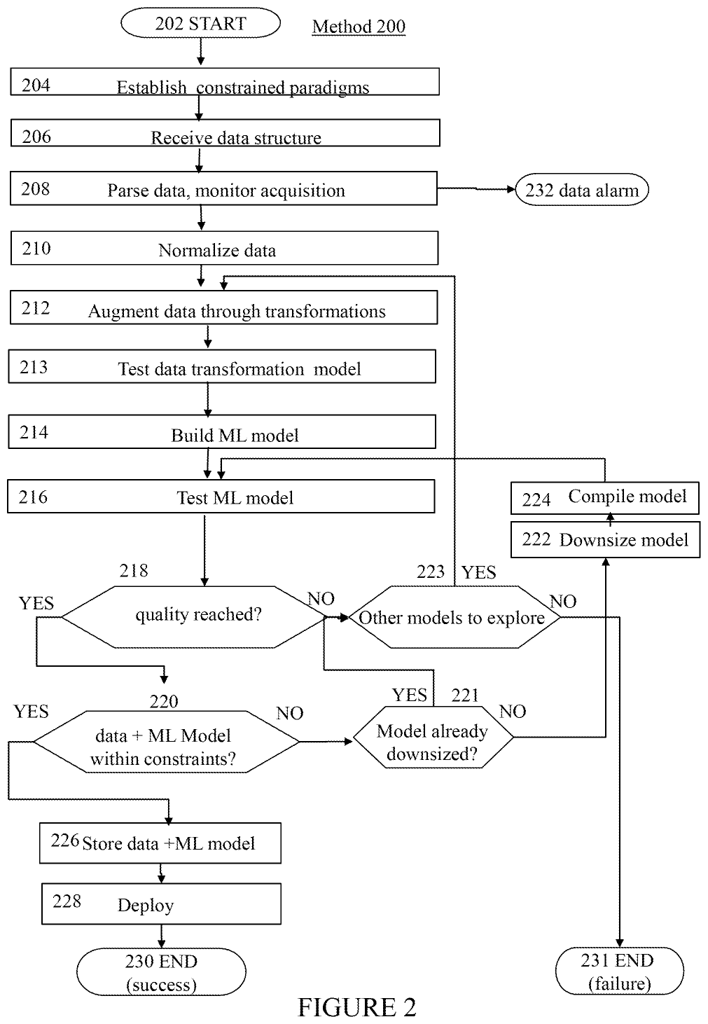

FIG. 2 shows one example of a computer-implemented method according to an implementation of the presently described technology

The present technology thus provides computer-implemented techniques and logic apparatus for providing improved control of the data digest and machine learning system.

As would be well known to one of skill in the computing art, data digest components are typically used for the provision of appropriate data that is usable by machine learning systems, and such data digest and machine learning systems typically require many hours of expert data analyst time to understand and tune the flow of data and metadata through the various stages of transformation and through the subsequent ML training and live use stages. It would therefore be desirable to deploy at least some automated assistive technology to reduce the time and resource consumption of such analysis and tuning activities.

The present technology provides a system according to various embodiments that acquires data input originating at the data source and transforms the data input through at least one intermediate data state into a transform output in a form usable by a model-based machine learning component. During the transformation process, the system runs saves data to run test iterations of the data digest and machine-learning model processes, compares the quality of the outcomes and determines whether a reduced quality outcome is still valid. The output of these determinations is then used to adjust the control parameters that control the data quality level of subsequently-provided data inputs from the data source. The control parameters may also need to be adjusted to take into account factors such as energy consumption by the transformation process, available memory capacity and the like. The feedback from the tests is used in this way to improve the functioning and efficiency of the transformation and machine learning processes. The test data may also be used to adjust the control parameters of the data-consuming machine-learning model. To allow for cases where the adjustments do not produce more efficient processing, the data input, the associated transform output and the relevant test and quality parameters can be stored for reuse—for example, to try different adjustments until a best-fit outcome is achieved, to provide a measure of the information loss over the course of the data processing, and to provide a trail of the treatment of the data and the reasoning processes for audit purposes.

In one simple example, data from various sensors is captured and transformed to provide daily averages of, for instance, temperature. The model consumes this transformed data to perform reasoning that can be used to adjust an automated irrigation system. The raw data from the various different types of sensors and other input sources needs to be transformed so that it is amenable to the types of mathematical and logical manipulation that form the basis of the machine learning system's reasoning. The provision of the transformed data consumes a certain amount of power. Supposing, for instance, that the monitoring of the transform process indicates that the daily average temperature could equally well be calculated using a lower resolution data transform, this would be desirable in increasing the efficiency of the data digest system. Similarly, if the monitoring of the transform process indicates that an adjustment to the operation of the data model is needed to accommodate a changed resolution of the transformed data, this could also be desirable in providing a useful outcome at reduced resource cost.

In FIG. 1, there is shown an example of a data digest system 100 according to an embodiment of the present technology, with an arrangement of logic, firmware or software components according to the presently described technology. Data acquisition system 100 receives input from the source constraints 101, comprising constraints related to:
the acquisition source, in particular the types of the sensors available (e.g. accelerometer, gyroscope, compass, thermometer, microphone, camera . . . ), the performance of these sensors (sampling rate, sensor precision (e.g. max number of G, description precision (number of bytes encoding), and the like);
the compute power of the system e.g. Arm® M4, RAM, flash memory, the libraries supported by the system e.g. CMSIS, and the like);
the goals: accuracy, precision, false positive thresholds, lag, frequency, energy budget, peak energy consumption, etc.;
further constraints may be added as the system runs and as the data digest process and the ML model are refined.

The data transform metadata system 112 comprises:
information about the relevant data transformations—for example, it may describe how to perform generic Fast Fourier Transforms (FFTs) when using the narrow band CMSIS FFT by making of a combination of—split into (band-pass filters+FFT+shift of results) and merge. Another example of data transformation is the calculation of the MEL-frequency cepstrum (MFCC) classically used in natural language processing. An MFCC is the succession of the following operations—FFT+power mapping over mel scale using triangular windows+logs of powers+discrete cosine transform;
settings of the data transformation algorithm giving size of sampling windows as well as their overlap and the data encoding leading to the highest quality data and ML output as reported in the scientific literature. Data will be acquired along with these parameters stored with the raw data allowing comparisons between settings used at different iterations;
definition of quality measurements of data, e.g. statistical measurements, entropy, lags, outage measurements, principal component analysis (PCA), peaks, etc.;
estimations of compute power, energy consumption and memory usage for data transformations as these parameters are critical for some applications and might be necessary to make trade-offs between data quality and energy consumption;
Other measurements might be added as the system acquires more parameters through reinforcement learning.

The data acquisition system 100 acquires the data through manufacturer specific means parametrized by the metadata and often reading the sensor data out of the sensor buffers through its own execution thread and presenting them as a line of data to the source system, along with a time stamp.

In one exemplary embodiment that might be implemented to reason about a user's environment from the data captured during a walk carrying a mobile (cellular) phone, mainly three types of data are extracted:

Timeseries=[timestamp, Vector of data] (e.g. accelerometer, gyroscope, compass, thermometer . . . );

Sound=[timestamp, audio]; and

Images/video=[timestamp, image/video].

In general, these data types produce a continuous flow of information at a given sampling rate described in source constraints 101 and transform metadata 112. However, in certain cases some pre-processing is already performed at the sensor level, leading to an asynchronous production of events, this is the case of vision sensors filtering out successive images without differences. This reduces drastically the volumes of data collected at the edge of IoT to focus on relevant events.

The collected data enters the acquisition monitor 102, either on regular time schedules or in event-driven mode. The data always comprises a timestamp plus a payload such as a vector, audio or image/video. The acquisition monitor checks the timestamps of incoming data against previous data from the same sensors, to assess the data input flow and detect outages and anomalies (such as throttling of the flow) as early as possible:
For continuous data, the acquisition module calculates the statistics of the data flow in particular the volume of the data flow as well as the variance of the payload data and compares them to the average values read in system 101 and transform metadata 112 to assess the stationarity of the sensor data. If the data flow drastically reduces, or if the sensor just sends a constant value or white noise, then the data acquisition monitor triggers an alert. This system detects, for example, the presence of a camera lens cap left in place.
For asynchronous data such as events, the data acquisition module checks the duration of the time without events and will raise an alarm if the event-less duration exceeds a given time. Some sensors in security or medical applications include a heartbeat event allowing to detect data outages within a given time span. The heartbeat values or max values are provided by the sources constraints system 101 and transform metadata 112.

Data is now formatted and normalized at 103. This operation abstracts the data away from their source and prepares it for pre-processing. As such all readings from accelerometers, all readings from gyroscopes, all temperature readings, video, images, etc. will be stored in standardized manners, to process them with the highest accuracy. One common representation is to describe the data in data frames and store them into a storage system 104, typically a database system which will be able to manipulate the information, sort it, and allow enhancing it through transformations, additions, groupings, tests and results. This storage system can collect the evolution of data from its raw form to its models, including all historic transformations as well as the settings from 101 and transform metadata 112 systems. As such the storage system records the complete set of parameters and the data generated and their quality according to measurements defined in transform metadata 112, allowing the system to reproduce the same experiments in the future and explore the influence of different parameters.

The data transformation monitor 105 accesses the transformation libraries 111 described in source constraints 101 and transform metadata 112. These libraries offer the classic signal processing functions, statistical packages, and the models for higher processing functions such as generic FFT and MFCC, peak detection and other classic data transformation methods, along with their parameters and quality measurements. The results of these transformations are stored into 104 storage, along with the raw data. It is important to note that the data transformations performed in 105 need to abide by the 101 resource constraints to be deployed along with the ML model into the target system.

Beyond preparing the data for the target system, the data transformation module performs exploration and test functions to assess the quality of the transformation results. For this task, the 105 system can use any compute resources, for example, in the cloud and parametrize it to reflect the constraints in 101 and transform metadata 112. After the exploratory work in the cloud, the data needs be mapped to the limitations and constraints in 101 and transform metadata 112, as the ultimate data preparation needs to work on a system with the source constraints of 101.

The data transformation test 113 is an independent system performing the performance tests of the transformation methods, assessing their results and storing them along with the data having generated them. Test 107 uses performance metrics such as the entropy of the transformed data, it can perform PCA to assess the principal components of the signal and calculate their loss, it can perform peak detection on the transformed data. All this information might be stored along with the data transformations to give additional measurement metrics. Some of these measurements allow to discard the transformation methods if the signal disappeared in the transformed data.

The Feature extraction table (Table 1) below describes an embodiment of data structures used to select the control parameters for data transformation 113 at the beginning of the reinforcement learning cycle. There are principally three families of sensors to work with: the vibrations which are a term encompassing the classic time-series such as accelerometers, gyroscopes, temperature as described earlier. The voice data are a term linked to the microphone data, and the vision sensors linked in camera, lidars, radars, x-rays etc.

TABLE 1
Feature extraction table

| | | | | | | | | | | Remaining |
|---|---|---|---|---|---|---|---|---|---|---|
| | | Sampling | | Raw | | | Feature | | Compression | information in |
| Family | Sensor | rate | | bandwidth | | Feature extraction | bandwidth | | ratio | % |
| Vibrations | Temperature | 1 | Hz | 2 | bps | none | 2 | bps | 1 | 100 |
| | Light | 1 | Hz | 1 | bps | none | 1 | bps | 1 | 100 |
| | Accelerometer | 16 | kHz | 48 | kbps | statistics | 48 | bps | 1000 | 60 |
| | Accelerometer | 16 | kHz | 48 | kbps | FFT | 1 | kbps | 48 | 80 |
| | Gyroscope | 16 | kHz | 24 | kbps | FFT | 500 | bps | 48 | 80 |
| Voice | Microphone | 32 | kHz | 48 | kbps | MFCC | 20 | kbps | 2.4 | 75 |
| Vision | Camera | 1 | Hz | 1 | Mbps | quadTree image | 250 | kbps | 4 | 60 |
| | Camera | 120 | Hz | 9 | Gbps | compressed video | 1 | Gbps | 9 | 75 |

Each sensor has typical sampling rates and bandwidth reported in the table along with feature extractions used for those cases. Low bandwidth data might be used raw, whereas higher bandwidth need some feature extraction allowing to extract and refine the information so as to reduce the volume of data sent to the ML system. Data compression rates are calculated along with information measurement in the compressed data, using classic measurements such as data entropy, or statistical analysis of the data. These measurements prove to be great control parameters when assessing the success of data preparation+ML and will actively contribute to improvement adjustments made during the reinforcement learning.

The ML monitor 106 takes the input data and tries several ML algorithms, typically using gradient descent methods to fine tune their parameters. Some methods like—linear regression, gradient boosting—provide the ranking of their features by order of importance. Those rankings may be used in the feedback loop to the data transformation monitor 105, by defining the features that can be dropped in subsequent flows to reduce resource consumption in the transform stages of the data digest process. In particular, this can help in moderating the resource intensive features in terms of computing power, energy consumption or memory space as defined in transform metadata 112. Several criteria are thus of interest in the consideration of potential features to be dropped: their added value in terms of ML accuracy, their computing costs in terms of operations per second or energy consumption, and the memory space that is consumed during the process.

The ML table (Table 2) below describes an embodiment of data structures used to select the best suited ML algorithms according to input data and the type of problems to solve. Vibration problems with small data might be solved directly with raw data and classic ML, more sophisticated problems rely typically on FFT to work in the frequency domain, filter data and feed it into classic ML or deep learning.

TABLE 2
ML + features

| Family | Sensor | Feature extraction | ML | Accuracy | Model Size | |
|---|---|---|---|---|---|---|
| Vibrations | Temperature | none | Linear regression | 0.93 | 12 | bytes |
| | Light | none | Naïve Bayes | 0.97 | 600 | bytes |
| | Accelerometer | signal statistics | Linear regression | 1 | 24 | bytes |
| | Accelerometer | FFT | NN | 0.97 | 40 | kB |
| | Gyroscope | FFT | Random Forest | 0.89 | 100 | kB |
| Voice | Microphone | MFCC | NN | 0.85 | 400 | kB |
| Vision | Camera | quadTree image | CNN | 0.87 | 1.2 | MB |
| | Camera | compressed video | LSTM | 0.75 | 300 | MB |

Voice recognition and wake-up word recognition use nearly exclusively MFCC and deep learning whereas vision problems use classic sets of data augmentations (image symmetries, rotations, shifts) followed by Convolutional Networks (CNN) or Long Short-Term Memory Networks (LSTM). Initially Table 2 is populated with existing experiences, and it will add more over time as the system runs and goes through the reinforcement learning.

Once a model is validated, it is recorded in storage 104 along with the data having created it.

The ML test 107 is an independent system performing the performance tests of all the methods and assessing their results and storing them along with the data from which they were generated, their configuration parameters, ML tests results (accuracy, precision, false positive, true positive), the quality results in terms of features used, energy consumption and memory use. As such, ML test 107 can compare the results of all types of ML algorithms, from linear regression to classic ML to deep learning and assess the results in terms of accuracy as well as energy consumption (simulated according to transform metadata 112 input data) and memory usage (simulated according to transform metadata 112 input data). ML test 107 might be run in parallel to ML, allowing use of ML optimization strategies and early pruning of algorithms. In general, transform metadata 112 suggests starting with the simplest ML algorithms, to set baselines for accuracy, memory usage and energy consumption.

Source constraints 101 are setting key parameters for these tests. If an algorithm is destined to work on a coin-cell battery and requires working over a duration of 5 years, the energy consumption factor might become the main driver of the application to be considered as of a higher priority than a given level of accuracy. One test parameter to be applied in such a case might be a requirement that the algorithm's energy consumption be kept smaller than or equal to a given maximum energy consumption. Another trade-off might be a requirement to reduce the decision-making frequency of the ML algorithm. In such a case the algorithm might use a longer observation window of the process and thus provide more accurate results as a trade-off against the algorithm's result frequency. One test might be the result frequency as compared to 101 constraints. Accordingly, algorithms could down-sample results to save energy.

In another example, the system may be adapted to apply other constraints that might exclude some ML algorithm's sensors and data transformations to fit into the energy constraints. In one example related to a process, monitoring a continuous window from 0 to 10 kHz might be replaced by a processor monitoring only two bands in this window: 0 to 2 kHz and 8 to 10 kHz. This saves about 60% of the energy consumed. Conversely for some other applications, the quality requirements of algorithms might impose band filters to exclude perturbation noise. The energy spent in these filters might allow simpler algorithms (e.g. linear versus deep learning) and save on the total energy budget.

Other constraints might include the time-lag of the results. For example, too long a lag might cause a prediction algorithm to result in checking the past, rather than predicting the future—which is clearly undesirable. For cases in which this constraint applies, algorithm accuracy can be traded for speed, to reduce the lag (incidentally also potentially reducing the energy consumption). Some data preparation processes and ML algorithms in transform metadata 112 are well known in the art to be slower than others, and this knowledge can be deployed in the present technology to achieve improvement to the data digest and ML system.

The results before optimization of the data transformation and after can be compared and stored, thus allowing documentation of the loss of information in case adjusted trade-offs are later needed to achieve improved outcomes.

Some models end up being small in size, for example linear regressions models take 10's of bytes. Models like SVM and Bayesian models are also small and are supported directly by CMSIS. On the other hand, deep learning models grow fast in size and reach 100's of KB to Megabytes. To run on embedded platforms these models need to be downsized by the system in 108. Classic methods consist of pruning, factorization and quantization. The selection and combination of these methods for any particular situation can be tuned by application of heuristic methods based on sampled or continuous feedback from instrumentation running alongside the main processes.

These downsized models are then compared to the original ones via the 107 ML test system to assess the loss of accuracy due to downsizing. These downsized models are stored in 104, prior to being compiled into program code, such as C/C++ code, by compile module 109. These compilation modules are able to calculate needs of these ML models in deployment for RAM as well as flash memory, taking many parameters into account: the linked libraries, the data buffers for the models, the data transformations, the model size, etc. These numbers are compared to the specifications of the deployment system in the 101 source constraint system.

Finally, the models (data transformation+ML) are send to the deployment system 110.

The quality measurements and tests allow optimizing ML models for accuracy, energy consumption, lag, and result frequency—as well as allowing trade-offs between these factors. These optimizations abide by the source constraints described in 101. After running optimization cycles, new data on process improvement is collected and can be used to fine tune ML algorithms in a given context by using the quality measurements.

Turning now to FIG. 2, there is shown an example of a computer-implemented method 200 according to the presently described data digest technology.

The method 200 begins at START 202, and at 204 a set of constrained paradigms for structuring input, processing and output of data in the data digest system are established. At least one part of the set of constrained paradigms is directed to the control of input, internal and external data structures and formats in the data digest system. At 206, a data structure comprises a descriptor defining how the structures of data available from a data source are received—this descriptor typically comprises data field names, data field lengths, data type definitions, data refresh rates, precision and frequency of measurements available, and the like. At 208, the data structure descriptor received at 206 is parsed, a process that typically involves recognition of the input descriptor elements and the insertion of syntactic and semantic markers to render the grammar of the descriptor visible to a subsequent processing component. In addition, some statistics on the input data flow and the data content are calculated to detect data outages or anomalies early and send an alarm 232 requesting assistance in case of anomaly. At 210 all data is normalized, allowing the application of the same data digest and ML processing tools for different makes and versions of sensors.

At 212 the relevant data transformations (like FFT, MFCC) are identified and applied to the data to describe a generic data structure to be used in the 214 ML algorithm. The test data transformation model 213 performs quantitative measurement on the data transforms, checks statistical properties (mean variance and the like), calculates the entropy, make PCA and peak detections allowing to compare different transforms. This allows early pruning of some transforms that do not carry useful or usable information. It also allows the system to assess the loss of information in the transforms (caused by, for example, smoothing and rounding actions) by comparing before and after measurements.

Function 214 tries different ML algorithms on the data set and uses optimization functions to fine-tune the ML parameters. The results of ML are tested in 216 to compare results of learning and test sets to determine the performance quality of the algorithms (accuracy, precision . . . ) as well as the fitting of the models. Test 218 determines if the algorithm reached the targeted quality without overfitting. If the test fails, test 223 checks if there are additional models to explore, if so, the algorithm loops back to 212, else the algorithm reaches the end on a failure to fulfil the goal. If quality test 218 succeeds, the flow continues with the test of the constraints of the model+data in 220. These constraints include miscellaneous parameters such as size of model, lag, frequency of model response as well as energy consumption . . . . If test 220 fails, it goes to test 221 checking if the model has already been downsized. If so, it goes to test 223 checking is here are remaining models to explore. Else the models get downsized in 222 using a mix of quantization, pruning and factorization to reduce the size of the ML model. The model is then compiled in 224 to become executable at the target board. This compilation calculates the size of the model in terms of RAM and flash memory. The newly compiled model feeds back into 216 to be tested and checked for quality prior to the acceptance tests 218 and 220. If both tests succeed, data and models are stored in 226 and get deployed in 228 to finally reach the END step 230 with a success.

In this way, the system according to embodiments acquires data input originating at the data source and transforms the data input through at least one intermediate data state into a transform output in a form usable by a model-based machine learning component. By running iterations of tests and balancing the information quality of the input data against a threshold value of validity of outcome, it is possible by means of the present technology to tune the data digest and machine-learning model system to improve its functioning and efficiency.

By applying monitoring instrumentation to the data digest and machine-learning model system, it thus becomes possible to incorporate automated assistive technology to tune the operation of the system.

As will be appreciated by one skilled in the art, the present technique may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product embodied in a non-transitory computer readable medium having computer readable program code embodied thereon. The computer readable medium may a non-transitory computer readable storage medium. A non-transitory computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present technique.

1. A computer-implemented method of operation of a model-based machine learning data digest system comprising:
acquiring a data input at a first data quality level originating at a data source;
storing a save copy of said data input at said first data quality level;
transforming said data input through at least one intermediate data state into a first transform output in a form usable by a model-based machine learning component;
performing a first test iteration of operation of said model-based machine learning component on said first transform output to derive a first test output;
retrieving said save copy of said data input at said first data quality level;
modifying a retrieved said save copy to a second data quality level;
transforming said retrieved said copy through at least one intermediate data state into a second transform output in a form usable by a model-based machine learning component;
performing a second test iteration of operation of said model-based machine learning component on said second transform output to derive a second test output;
comparing at least one validity measure of said first and said second test output; and
responsive to a finding that said at least one validity measure of said second test output is equal to or greater than said at least one validity measure of said first test output, communicating an instruction to said data source to provide at least one future instance of data input at said second data quality level.

2. The computer-implemented method of claim 1, further comprising adjusting at least one control parameter of said model-based machine learning component.

3. The computer-implemented method of claim 1, further comprising adjusting at least one control parameter of a transform stage component.

4. The computer-implemented method of claim 1, further comprising storing said save copy of said data input, said transform output and said instruction to said data source for reuse.

5. The computer-implemented method of claim 1, said transforming further comprising applying at least one function from at least one transform library.

6. The computer-implemented method of claim 1, said data source comprising at least one sensor.

7. An electronic apparatus for controlling a model-based machine learning data digest system, comprising electronic logic to:
acquire a data input signal at a first data quality level originating at a data source; store a save copy of said data input signal at said first data quality level;
transform said data input signal through at least one intermediate data state into a first transform output in a form usable by a model-based machine learning component;
perform a first test iteration of operation of said model-based machine learning component on said first transform output to derive a first test output;
retrieve said save copy of said data input signal at said first data quality level;
modifying a retrieved said save copy to a second data quality level;
transform said retrieved said copy through at least one intermediate data state into a second transform output in a form usable by a model-based machine learning component;
perform a second test iteration of operation of said model-based machine learning component on said second transform output to derive a second test output;
compare at least one validity measure of said first and said second test output; and
responsive to a finding that said at least one validity measure of said second test output is equal to or greater than said at least one validity measure of said first test output, communicating an instruction to said data source to provide at least one future instance of data input signal at said second data quality level.

8. The electronic apparatus of claim 7, further comprising electronic logic to adjust at least one control parameter of said model-based machine-learning component.

9. The electronic apparatus of claim 7, further comprising electronic logic to adjust at least one control parameter of a transform stage.

10. The electronic apparatus of claim 7, further comprising electronic logic and storage to store said data input signal, said transform output and said instruction to said data source for reuse.

11. The electronic apparatus of claim 7, said electronic logic operable to transform said data input signal further comprising electronic logic to apply at least one function from at least one transform library.

12. The electronic apparatus of claim 7, said data source comprising at least one sensor.

13. A computer program product stored on a non-transitory computer-readable medium and comprising computer program instructions to cause a computer to perform steps of:
acquiring a data input at a first data quality level originating at a data source;
storing a save copy of said data input at said first data quality level;
transforming said data input through at least one intermediate data state into a first transform output in a form usable by a model-based machine learning component;
performing a first test iteration of operation of said model-based machine learning component on said first transform output to derive a first test output;
retrieving said save copy of said data input at said first data quality level;
modifying a retrieved said save copy to a second data quality level;
transforming said retrieved said copy through at least one intermediate data state into a second transform output in a form usable by a model-based machine learning component;
performing a second test iteration of operation of said model-based machine learning component on said second transform output to derive a second test output;
comparing at least one validity measure of said first and said second test output; and
responsive to a finding that said at least one validity measure of said second test output is equal to or greater than said at least one validity measure of said first test output, communicating an instruction to said data source to provide at least one future instance of data input at said second data quality level.

14. The computer program product of claim 13, further comprising adjusting at least one control parameter of said model-based machine learning component.

15. The computer program product of claim 13, further comprising adjusting at least one control parameter of a transform stage component.

16. The computer program product of claim 13, further comprising storing said save copy of said data input, said transform output and said instruction to said data source for reuse.

17. The computer program product of claim 13, said transforming further comprising applying at least one function from at least one transform library.

18. The computer program product of claim 13, said data source comprising at least one sensor.
